(19) United States
(12) Patent Application Publication
(10) Pub. No.: US 2025/0323917 A1
(43) Pub. Date: Oct. 16, 2025

(54) SCALABLE PUBLIC TURING TEST USING ANIMATION CLIPS

(71) Applicant: Microsoft Technology Licensing, LLC, Redmond, WA (US)

(72) Inventor: Saurav BHATTACHARYA, Bothell, WA (US)

(21) Appl. No.: 18/634,007

(22) Filed: Apr. 12, 2024

(51) Int. Cl. H04L 9/40

(52) U.S. Cl. CPC H04L 63/10

(57) ABSTRACT

Example implementations include a method, apparatus, and computer-readable medium configured for controlling access to computer resources based on animations. A computer system transmits at least three animations for display to the user on a client device. At least a first animation and a second animation are associated with a respective correct label and at least a third animation is not associated with a correct label. The computer system receives an input of a respective selected label for each of the animations. The computer system determines whether to allow access to the user based on the respective selected labels of the first animation and the second animation being the respective correct labels. The computer system associates the respective selected label for the third animation with the third animation as a potential label for the third animation in response to determining to allow access to the user.

### TECHNICAL FIELD

The present disclosure relates to a scalable public Turing test using animation clips for controlling access to computer resources.

### BACKGROUND

Computer systems have limited resources to provide services to users. Even where the available resources can be scaled, there are costs associated with increased usage. Often, a provider of computer systems intends the system to be used by human users. An automated system, which may be referred to as a bot, may also access a computer system. Such bots may consume resources intended for human users. For instance, a bot may submit requests to the computer system at a much faster rate than a human user. Accordingly, techniques for limiting bots from accessing a computer system help conserve resources for the human users and can reduce overall consumption of resources.

One technique for determining whether a user is a human is referred to as a completely automated public Turing test to tell computers and humans apart (CAPTCHA). A CAPTCHA typically includes a puzzle to solve that is easy for a human but difficult for a computer. A computer system may present a CAPTCHA to a user prior to granting access to computing resources such as a website or database. Common CAPTCHAS typically involve an image, and the user is requested to provide some analysis of the image such as interpretation of distorted characters or selection of images that match a description.

Advances in image recognition and other machine-learning techniques have degraded the ability of CAPTCHAs to distinguish between bots and humans. A bot may be trained to perform an image-based CAPTCHA task and gain access to the computer resources. Accordingly, there is a need for improved CAPTCHAs.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to an apparatus for verifying whether to allow a user access to a resource, including: one or more memories storing computer-executable instructions; and one or more processors configured to execute the instructions, wherein execution of the instructions causes the apparatus to: transmit at least three animations for display to the user on a client device, wherein at least a first animation and a second animation of the at least three animations are associated with a respective correct label and at least a third animation of the animations is not associated with a correct label; receive, from the client device, an input of a respective selected label for each of the at least three animations; determine whether to allow access to the user based at least in part on the respective selected label of the first animation being the respective correct label for the first animation and the respective selected label of the second animation being the respective correct label for the second animation; and associate the respective selected label for the third animation with the third animation as a potential label for the third animation in response to determining to allow access to the user.

In some aspects, the techniques described herein relate to a method of verifying whether to allow a user access to a resource, including: transmitting at least three animations for display to the user on a client device, wherein at least a first animation and a second animation of the at least three animations are associated with a respective correct label and at least a third animation of the animations is not associated with a correct label; receiving, from the client device, an input of a respective selected label for each of the at least three animations; determining whether to allow the user access to the resource based at least in part on the respective selected label of the first animation being the respective correct label for the first animation and the respective selected label of the second animation being the respective correct label for the second animation; and associating the respective selected label for the third animation with the third animation as a potential label for the third animation in response to determining to allow access to the user.

In some aspects, the techniques described herein relate to a non-transitory computer-readable medium including computer-executable instructions for verifying whether to allow a user access to a resource, wherein execution of the instructions by a processor causes the processor to: transmit at least three animations for display to the user on a client device, wherein at least a first animation and a second animation of the at least three animations are associated with a respective correct label and at least a third animation of the animations is not associated with a correct label; receive, from the client device, an input of a respective selected label for each of the at least three animations; determine whether to allow access to the user based at least in part on the respective selected label of the first animation being the respective correct label for the first animation and the respective selected label of the second animation being the respective correct label for the second animation; and associate the respective selected label for the third animation with the third animation as a potential label for the third animation in response to determining to allow access to the user.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram of an example of an architecture for a system to implement an animation-based access control system, in accordance with aspects described herein.

FIG. 2 is a diagram of an example user interface for presenting an animation-based CAPTCHA, in accordance with aspects described herein.

FIG. 3 is a diagram of an example record for an animation, in accordance with aspects described herein.

FIG. 4 is a logical flowchart of an example method for managing animations for use in a CAPTCHA, in accordance with aspects described herein.

FIG. 5 is a schematic diagram of an example of an apparatus for implementing a animation-based access control system.

FIG. 6 is a flow diagram of an example of a method for controlling access to computing resources using animations.

FIG. 7 illustrates an example of a device including additional optional component details as those shown in FIG. 5.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known components are shown in block diagram form in order to avoid obscuring such concepts.

This disclosure describes animation-based techniques for controlling access to computer resources. Instead of presenting a user with a simple image to analyze, an example computer system implementing an animation-based CAPTCHA may present a user with a plurality of animations for the user to label. If the user is able to correctly label the animations, the user is granted access to computer resources. Further, when the user is granted access, the system may assume that the user is a human and that labels provided for other animations are correct labels. Accordingly, animations where a correct label is not associated with an animation may be presented to the allowed user for labelling. The labels provided by allowed users may be used to expand a pool of labeled animations, which may increase the difficulty of solving the animation-based CAPTCHA for bots.

The task of labeling animations may help overcome machine-learning based techniques for training bots to solve CAPTCHAs. While an animation shares similarities with an image, the additional information available in an animation may be difficult for a computer to efficiently analyze. Image recognition using machine-learning may extract features (e.g., lines, colors, patterns) from an image and then attempt to classify those features based on similarity to features of images in a training set. Animation complicates this task by adding additional dimensions of time and activity. In particular, training a bot to detect an activity is a difficult task. Although there are machine-learning models for detecting particular activities, those models are typically trained on a narrow class of subjects and small range of activities. In an aspect, the animations used in the animation-based access control may have variable subjects and a wide variety of actions. For example, the animations may include video clips or animated drawings, and the subjects may include humans, animals, plants, aliens, or inanimate objects. For instance, animations involving an anthropomorphized animal performing an action may be difficult for a bot to label because there is a low likelihood that an activity model is trained on an animal for human actions.

There may be a relatively small pool of correctly labeled animations suitable for use in a CAPTCHA. If a CAPTCHA utilizes a limited set of puzzles, a bot may be trained to correctly solve repeated puzzles. In an aspect, the present disclosure provides techniques for unlabeled animations to be presented to users. When a user correctly identifies the labels for known animations, the labels applied to the unlabeled animations may be associated with the unlabeled animation. When multiple labels for an unlabeled animation provide confidence that the provided labels are correct, the previously unlabeled animation may be considered a labeled animation and used in subsequent CAPTCHAs. Accordingly, the pool of correctly labeled animations may continuously grow, thereby increasing the difficulty of training a bot to solve the CAPTCHA.

Implementations of the present disclosure may realize one or more of the following technical effects. The use of animation-based access control may limit access to intended users, for example, by excluding bots. Accordingly, computer-resource for the intended users may be conserved to provide better performance for those users (e.g., faster response times). Further, security may be improved by preventing a bot from attempting to collect unauthorized information or make repeated access attempts.

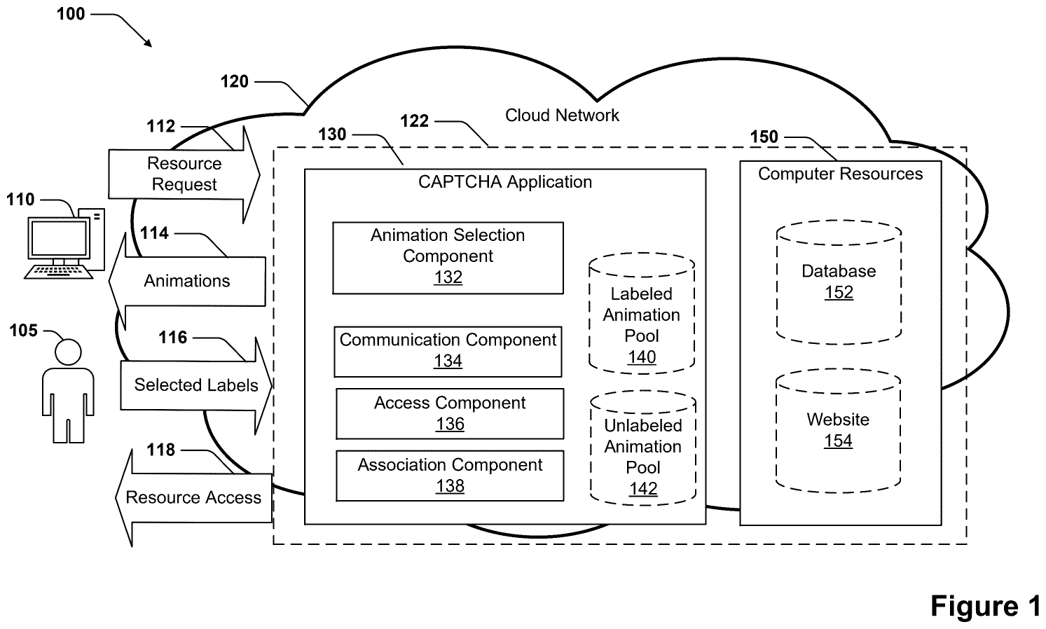

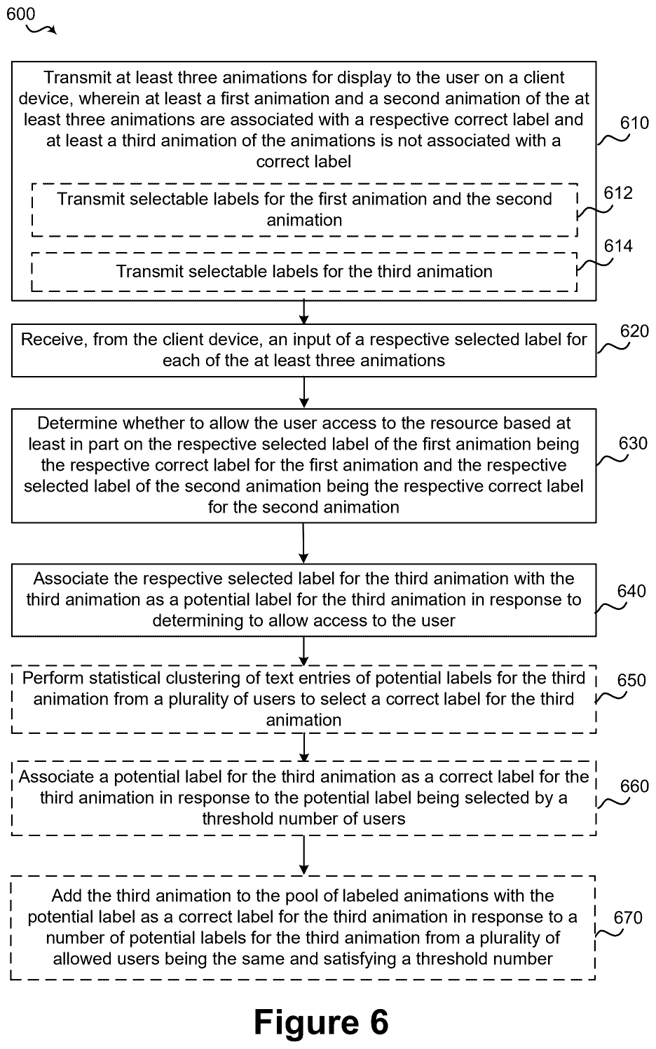

Turning now to FIGS. 1-7, examples are depicted with reference to one or more components and one or more methods that may perform the actions or operations described herein, where components and/or actions/operations in dashed line may be optional. Although the operations described below in FIG. 6 are presented in a particular order and/or as being performed by an example component, the ordering of the actions and the components performing the actions may be varied, in some examples, depending on the implementation. Moreover, in some examples, one or more of the actions, functions, and/or described components may be performed by a specially-programmed processor, a processor executing specially-programmed software or computer-readable media, or by any other combination of a hardware component and/or a software component capable of performing the described actions or functions.

FIG. 1 is a conceptual diagram 100 of an example of an architecture for a system 120 to control access to a computer system based on animations. The system 120 may be, for example, a cloud network including computing resources that are controlled by a network operator and accessible to public clients such as a client device 110 operated by a user 105. For example, the system 120 may include a plurality of datacenters 122 that include computing resources such as computer memory and processors. In some implementations, the computer resources 150 may include stored data such as a database 152 or a website 154. In some implementations, the datacenters 122 may host a compute service that provides computing nodes on computing resources 150 located in the datacenter. The computing nodes may be containerized execution environments with allocated computing resources. For example, the computing nodes may be virtual machines (VMs), process-isolated containers, or kernel-isolated containers. The nodes may be instantiated at a datacenter 122 and imaged with software (e.g., operating system and applications for a service). The system 120 may include edge routers that connect the datacenters 122 to external networks such as internet service providers (ISPs) or other autonomous systems (ASes) that form the Internet.

The system 120 may provide a CAPTCHA application 130 configured to control access to the computer resources 150. For example, the CAPTCHA application 130 may use animations and the task of animation labeling to distinguish between human users 105 and non-human users (e.g., bots). The CAPTCHA application 130 may include an animation selection component 132, a communication component 134, an access component 136, and an association component 138. The CAPTCHA application 130 may store a labeled animation pool 140 and an unlabeled animation pool 142. The animation selection component 132 is configured to select a plurality of animations for a CAPTCHA challenge. In some implementations, the animation selection component 132 is configured to select at least two labeled animations from labeled animation pool 140 and one unlabeled animation from unlabeled animation pool 142. The communication component 134 is configured to send the selected animations to the client device 110 and receive a response including labels for the animations from the user 105. The access component 136 is configured to determine whether to grant access to the user 105 based on the labels provided by the user 105. The association component 138 is configured to associate a label selected for an unlabeled animation with the unlabeled animation when the user is granted access to the computer resource 150.

In an example interaction, a user 105 may request a computer resource 150 via the client device 110. For example, the user 105 may transmit a resource request 112 to view a webpage, run a database query, or access an account. The CAPTCHA application 130 and/or the animation selection component 132 may select at least two animations 114 from the labeled animation pool 140. In some implementations, the animation selection component 132 may select animations having different actors or different types of actors to decrease a likelihood that a bot will be able to correctly label different types of animations. In some implementations, the animation selection component 132 may generate a set of selectable labels for one or more of the animations. For labeled animations, the set of selectable labels includes a correct label associated with the animation. The other labels may be randomly generated, for example, by selecting from lists of potential actors and actions. For unlabeled animations, the selectable labels may include potential labels provided by other users, or randomly generated labels. The animation selection component 132 may also select one or more unlabeled animations. The communication component 134 may transmit the selected animations 114 to the client device 110, optionally including the set of selected labels for one or more of the animations. For instance, the communication component 134 may generate a web interface including the selected animations and an input mechanism for the user to enter labels, for example, by selecting a label or entering text.

The client device 110 may present the animations to the user 105. The client device 110 may receive the input of a selected label for each animation from the user 105. The client device 110 may transmit the selected labels 116 to the CAPTCHA application 130, where the selected labels 116 may be received by the communication component 134.

The CAPTCHA application 130 and/or the access component 136 may determine whether to allow the user 105 access to the computer resource 150 based at least in part on the selected labels. In some implementations, the access component 136 is configured to allow access when a respective selected label of a first labeled animation is the respective correct label for the first animation and a respective selected label of a second labeled animation is the respective correct label for the second animation. That is, access is 0) 37834.01538 allowed when each of the labeled animations is correctly labeled by the user 105. The access component 136 may provide resource access 118 or the computer resource 150 itself to the client device 110 when access is allowed.

The CAPTCHA application 130 and/or the association component 138 may associate the respective selected label for a third animation with the third unlabeled animation as a potential label for the third animation in response to determining to allow access to the user. A potential label may refer to a label that has been selected by a user that has been granted access. A potential label may become a correct label when a confidence in the potential label is sufficient (e.g., based on a clustering score or a threshold number of selections).

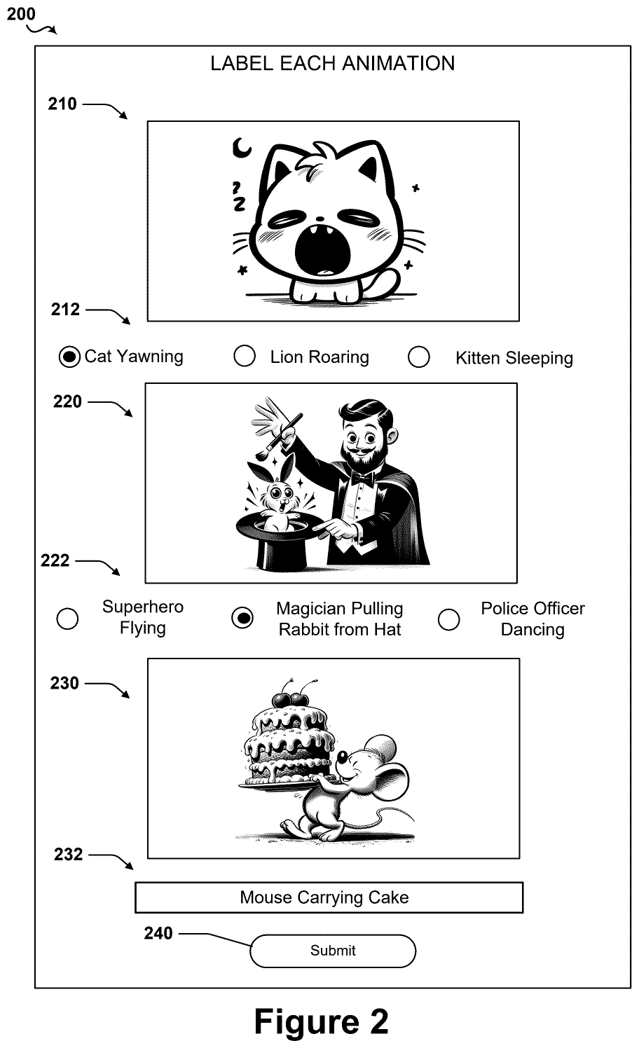

FIG. 2 is a diagram of an example user interface 200 for presenting an animation-based CAPTCHA. The user interface 200 may be, for example, a webpage described by hypertext markup language (HTML) and displayed on a browser application of the client device 110. In the illustrated example, the user interface 200 includes a plurality of animations (e.g., animations 114) including a first animation 210, a second animation 220, and a third animation 230. The animations may be any known computer file for storing animations or video. For example, the animations may be graphics interchange format (GIF) files, moving picture experts group (MPEG) files, or other file formats. Each animation is associated with an input mechanism for selecting a label of the respective animation. For instance, the input mechanism may be a plurality of radio buttons that are each associated with a respective selectable label 212 provided by the CAPTCHA application 130. The selectable labels 212 include the correct label for the respective animation, but the user interface 200 does not include an indication of the correct label. As another example, the input mechanism may include a text box 232. In some implementations, labeled animations may use an input mechanism with selectable labels and unlabeled animations may use the text box 232. In some implementations, the input mechanism may include both selectable labels and a text box 232.

The user interface 200 may include a button 240 to submit the selected labels. For instance, selection of the submit button 240 may generate an HTML PUT or POST command including the selected labels.

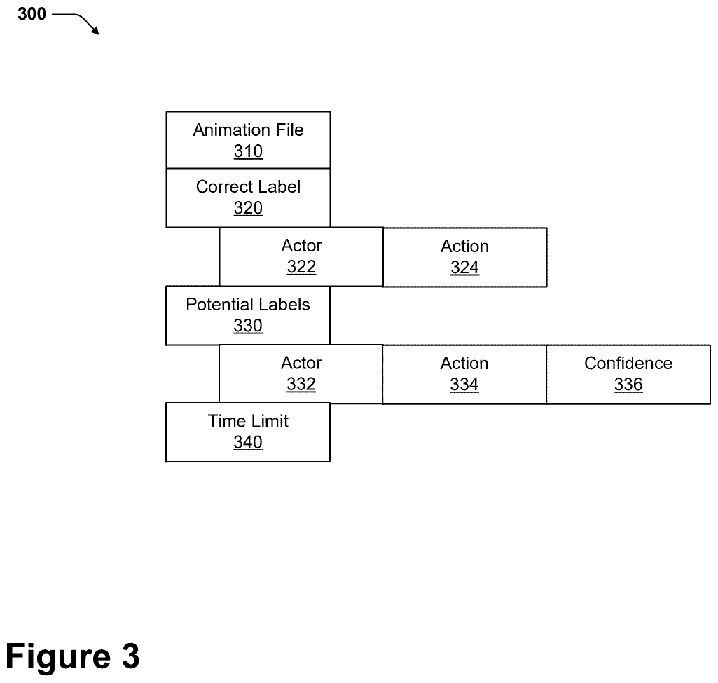

FIG. 3 is a diagram of an example record 300 for an animation. The record 300 may represent an animation and may be stored in the labeled animation pool 140 or the unlabeled animation pool 142. The record 300 includes an animation file 310, which may be a file name or link to a file. The record 300 may include a correct label 320 if the animation is a labeled animation. In some implementations, the correct label 320 includes at least an actor 322 and an action 324. The actor 322 and the action 324 may be compared to respective dictionaries (e.g., nouns and verbs) to ensure the label follows a correct format. The record 300 may include one or more potential labels 330 that have been selected by a user. A potential label 330 may include an actor 332 and action 334 similar to the actor 322 and action 324. The potential label 330 may also include a confidence score 336 that indicates how likely the potential label is to be a correct label. For example, the confidence score 336 may be a number of times that the potential label was selected, a percentage of times that the potential label was selected, or a score assigned by a clustering algorithm. The potential label 330 may become a correct label 320 when the confidence score 336 satisfies a threshold. The record 300 may include a time limit 340 that indicates an amount of time. In some implementations, in order to be granted access, the user may need to correctly label the animation within a time limit. The time limit for multiple animations may be a sum of the time limit 340 for each animation. The time limit 340 may be adjusted, for example, based on a length of the animation or an average response time for the animation.

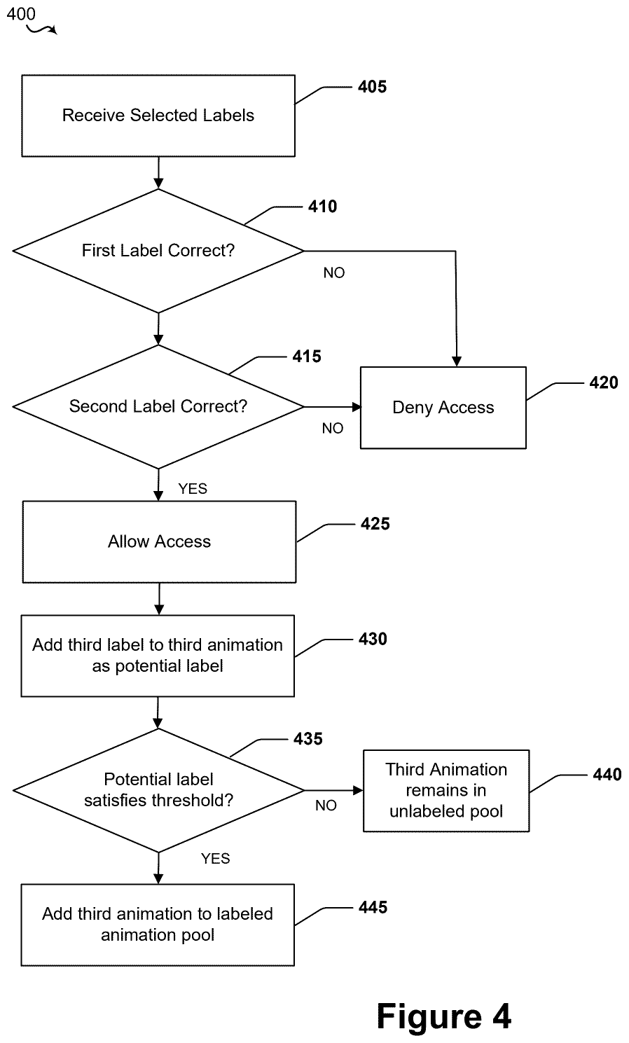

FIG. 4 is a logical flowchart of an example method 400 for managing animations for use in a CAPTCHA. The method 400 may be performed by the CAPTCHA application 130 or components thereof. In block 405, the CAPTCHA application 130 (e.g., communication component 134) receives the selected labels 116. In block 410, the CAPTCHA application 130 (e.g., access component 136) determines whether the first label is correct, for example, by comparing a respective selected label with the respective correct label 320. The method 400 proceeds to block 415 if the first label is correct, or proceeds to block 420 if the first label is not correct. Similarly, in block 415, the CAPTCHA application 130 (e.g., access component 136) determines whether the second label is correct, for example, by comparing a respective selected label with the respective correct label 320. The method 400 proceeds to block 425 if the second label is correct, or proceeds to block 420 if the second label is not correct. In block 420, the CAPTCHA application 130 (e.g., access component 136) denies access if either the first label or the second label was incorrect, and the method 400 ends. In block 425 the CAPTCHA application 130 (e.g., access component 136) allows access if both the first label and the second label are correct, and the method 400 proceeds to block 430. In block 430, the CAPTCHA application 130 (e.g., association component 138) adds the third label to the third animation as a potential label 330. The association component 138 may check a syntax of the actor 332 and/or action 334. The association component 138 may change a form of a user entered word to match a label format. At block 435, the CAPTCHA application 130 (e.g., association component 138) may determine whether the potential label 330 satisfies a threshold. For example, the association component 138 may compare the confidence score 336 to a threshold. If the potential label does not satisfy the threshold, the method 400 proceeds to block 440, where the third animation remains in the unlabeled animation pool 142. If the potential label does satisfy the threshold, the method 400 proceeds to block 445, where the third animation is added to the labeled animation pool 140.

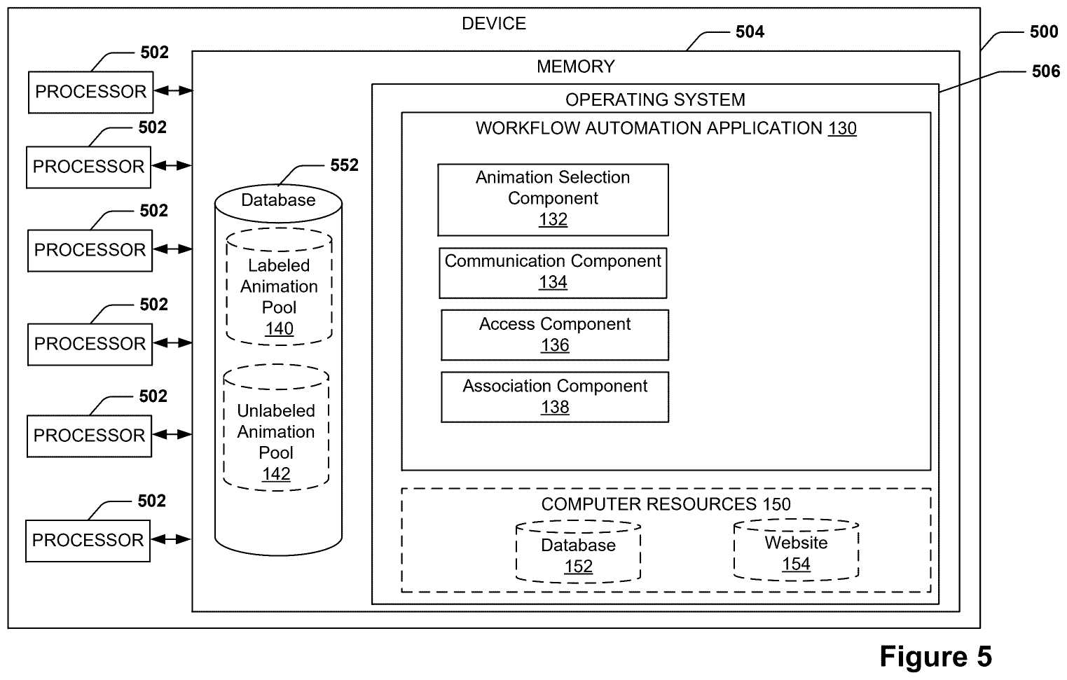

FIG. 5 is a schematic diagram of an example of an apparatus 500 (e.g., a computing device) for implementing an animation-based access control system. The apparatus 500 may be implemented as one or more computing devices in the system 120.

In an example, the apparatus 500 includes at least one processor 502 and a memory 504 configured to execute or store instructions or other parameters related to providing an operating system 506, which can execute one or more applications or processes, such as, but not limited to, the CAPTCHA application 130. For example, processors 502 and memory 504 may be separate components communicatively coupled by a bus (e.g., on a motherboard or other portion of a computing device, on an integrated circuit, such as a system on a chip (SoC), etc.), components integrated within one another (e.g., a processor 502 can include the memory 504 as an on-board component), and/or the like. Memory 504 may store instructions, parameters, data structures, etc. for use/execution by processor 502 to perform functions described herein. In some implementations, the memory 504 includes the database 552 for use by the CAPTCHA application 130, for example, to store the labeled animation pool 140 and the unlabeled animation pool 142. In some implementations, the apparatus 500 includes the computer resources 150.

In an example, the CAPTCHA application 130 includes the animation selection component 132, the communication component 134, the access component 136, and the association component 138 discussed above with respect to FIG. 1.

In some implementations, the apparatus 500 is implemented as a distributed processing system, for example, with multiple processors 502 and memories 504 distributed across physical systems such as servers, virtual machines, or datacenters 122. For example, one or more of the components of the CAPTCHA application 130 may be implemented as services executing at different datacenters 122. The services may communicate via an API.

FIG. 6 is a flow diagram of an example of a method 600 for controlling access to computing resources using animations. For example, the method 600 can be performed by the CAPTCHA application 130, the apparatus 500 and/or one or more components thereof to controlling access to computing resources 150 using animations.

At block 610, the method 600 includes transmitting at least three animations for display to the user on a client device. For example, in an aspect, apparatus 500, processor 502, memory 504, and/or CAPTCHA application 130 may be configured to or may comprise means for transmitting at least three animations for display to the user on a client device. At least a first animation 210 and a second animation 220 of the at least three animations are associated with a respective correct label and at least a third animation 230 of the animations is not associated with a correct label. For example, the CAPTCHA application 130 and/or the animation selection component 132 may select the first animation 210 and the second animation 220 from the labeled animations pool 142 and select the third animation 230 from the unlabeled animation pool 142. In some implementations, the respective correct label 320 includes an indication of an actor 322 in the animation and an indication of an action 324 in the animation. The animation selection component 132 may select the first animation and the second animation such that the actor 322 in the first animation is different than the actor 322 in the second animation.

In some implementations, at sub-block 612, the block 610 may optionally include transmitting selectable labels 212 and 222 for the first animation 210 and the second animation 220. The selectable labels 212 and 222 include the respective correct label for the first animation 210 and the respective correct label for the second animation 220 to be displayed with at least two incorrect labels for each of the first animation and the second animation. The user 105 selects the input of the respective selected label for each of the first animation and the second animation from the selectable labels.

In some implementations, at sub-block 614, the block 610 may optionally include transmitting selectable labels for the third animation 230. The selectable labels for an unlabeled animation may include randomly generated combinations of actors and actions or potential labels 330 for the third animation that were previously input by other users.

At block 620, the method 600 includes receiving, from the client device, an input of a respective selected label for each of the at least three animations. For example, in an aspect, apparatus 500, processor 502, memory 504, CAPTCHA application 130, and/or communication component 134 may be configured to or may comprise means for receiving, from the client device 110, an input of a respective selected label 116 for each of the at least three animations.

At block 630, the method 600 includes determining whether to allow the user access to the resource based at least in part on the respective selected label of the first animation being the respective correct label for the first animation and the respective selected label of the second animation being the respective correct label for the second animation. For example, in an aspect, apparatus 500, processor 502, memory 504, and/or the CAPTCHA application 130 may be configured to or may comprise means for determining whether to allow the user 105 access to the resource 150 based at least in part on the respective selected label 116 of the first animation 210 being the respective correct label 320 for the first animation and the respective selected label 116 of the second animation being the respective correct label 320 for the second animation 220. For example, the CAPTCHA application 130 and/or the access component 136 may execute blocks 410 and 415 of the method 400 to determine whether to allow access or deny access. In some implementations, determining whether to allow access to the user 105 is also based on whether the input of the respective selected label for each of the at least three animations is received within a time limit 340.

At block 640, the method 600 includes associating the respective selected label for the third animation with the third animation as a potential label for the third animation in response to determining to allow access to the user. For example, in an aspect, apparatus 500, processor 502, memory 504, and/or the CAPTCHA application 130 may be configured to or may comprise means for associating the respective selected label for the third animation with the third animation as a potential label for the third animation in response to determining to allow access to the user. For example, the CAPTCHA application 130 and/or the association component 138 may associate the respective selected label 116 for the third animation 230 with the third animation as a potential label 330 for the third animation in response to determining to allow access to the user 105.

At block 650, the method 600 may optionally include performing statistical clustering of text entries of potential labels for the third animation from a plurality of users to select a correct label for the third animation. For example, in an aspect, apparatus 500, processor 502, memory 504, and/or the CAPTCHA application 130 may be configured to or may comprise means for performing statistical clustering of text entries of potential labels for the third animation from a plurality of users to select a correct label for the third animation. For example, the association component 138 may perform statistical clustering of text entries input via text box 232. For instance, the association component 138 may normalize the text entries using dictionaries to use the same spelling and form for the actor 332 and action 334. The association component 138 may determine a confidence score for a potential label 330 based on a number of users selecting the potential label 330 and a semantic embedding indicating similar meanings of other user entered labels.

At block 660, the method 600 may optionally include associating a potential label for the third animation as a correct label for the third animation in response to the potential label being selected by a threshold number of users. For example, in an aspect, apparatus 500, processor 502, memory 504, and/or the CAPTCHA application 130 may be configured to or may comprise means for associating a potential label for the third animation as a correct label for the third animation in response to the potential label being selected by a threshold number of users. For example, the association component 138 may associate a potential label 330 for the third animation as a correct label 320 for the third animation in response to the 330 potential label being selected by a threshold number of users. For example, the confidence score 336 may be a number or percentage of users that have selected the label or a result of statistical clustering.

Referring to an alternative or additional aspect, at block 670, the method 600 may further include adding the third animation to the pool of labeled animations with the potential label as a correct label for the third animation in response to a number of potential labels for the third animation from a plurality of allowed users being the same and satisfying a threshold number. For example, in an aspect, apparatus 500, processor 502, memory 504, the CAPTCHA application 130, and/or association component 138 may be configured to or may comprise means for adding the third animation 230 to the labeled animation pool 140 with the potential label 330 as a correct label 320 for the third animation in response to the number of potential labels for the third animation (e.g., confidence score 336) from a plurality of allowed users being the same and satisfying a threshold number.

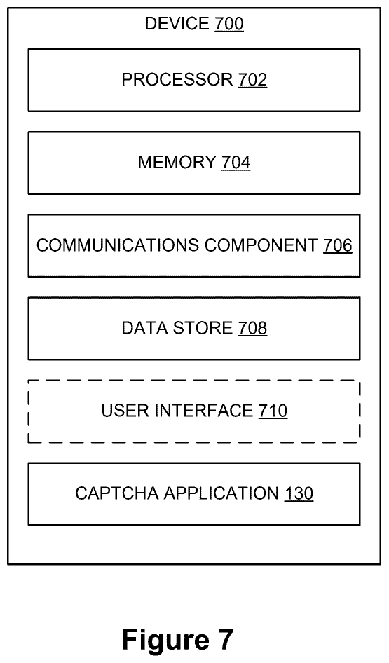

FIG. 7 illustrates an example of a device 700 including additional optional component details as those shown in FIG. 5. In one aspect, device 700 includes processor 702, which may be similar to processor 702 for carrying out processing functions associated with one or more of components and functions described herein. Processor 702 can include a single or multiple set of processors or multi-core processors. Moreover, processor 702 can be implemented as an integrated processing system and/or a distributed processing system.

Device 700 further includes memory 704, which may be similar to memory 504 such as for storing local versions of operating systems (or components thereof) and/or applications being executed by processor 702, such as the CAPTCHA application 130, animation selection component 132, communication component 134, access component 136, association component 138, etc. Memory 704 can include a type of memory usable by a computer, such as random access memory (RAM), read only memory (ROM), tapes, magnetic discs, optical discs, volatile memory, non-volatile memory, and any combination thereof. The processor 702 may execute instructions stored on the memory 704 to cause the device 700 to perform the methods discussed above with respect to FIGS. 4 and 6.

Further, device 700 includes a communications component 706 that provides for establishing and maintaining communications with one or more other devices, parties, entities, etc. utilizing hardware, software, and services as described herein. Communications component 706 carries communications between components on device 700, as well as between device 700 and external devices, such as devices located across a communications network and/or devices serially or locally connected to device 700. For example, communications component 706 may include one or more buses, and may further include transmit chain components and receive chain components associated with a wireless or wired transmitter and receiver, respectively, operable for interfacing with external devices.

Additionally, device 700 may include a data store 708, which can be any suitable combination of hardware and/or software, that provides for mass storage of information, databases, and programs employed in connection with aspects described herein. For example, data store 708 may be or may include a data repository for operating systems (or components thereof), applications, related parameters, etc. not currently being executed by processor 702. In addition, data store 708 may be a data repository for the CAPTCHA application 130.

Device 700 may optionally include a user interface component 710 operable to receive inputs from a user of device 700 and further operable to generate outputs for presentation to the user. User interface component 710 may include one or more input devices, including but not limited to a keyboard, a number pad, a mouse, a touch-sensitive display, a navigation key, a function key, a microphone, a voice recognition component, a gesture recognition component, a depth sensor, a gaze tracking sensor, a switch/button, any other mechanism capable of receiving an input from a user, or any combination thereof. Further, user interface component 710 may include one or more output devices, including but not limited to a display, a speaker, a haptic feedback mechanism, a printer, any other mechanism capable of presenting an output to a user, or any combination thereof.

Device 700 additionally includes the CAPTCHA application 130 for controlling access to computer resources 150 using animations.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, one or more of the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media. Non-transitory computer-readable media excludes transitory signals.

The following numbered clauses provide an overview of aspects of the present disclosure:
Clause 1. An apparatus for verifying whether to allow a user access to a resource, comprising: one or more memories storing computer-executable instructions; and one or more processors configured to execute the instructions, wherein execution of the instructions causes the apparatus to: transmit at least three animations for display to the user on a client device, wherein at least a first animation and a second animation of the at least three animations are associated with a respective correct label and at least a third animation of the animations is not associated with a correct label; receive, from the client device, an input of a respective selected label for each of the at least three animations; determine whether to allow access to the user based at least in part on the respective selected label of the first animation being the respective correct label for the first animation and the respective selected label of the second animation being the respective correct label for the second animation; and associate the respective selected label for the third animation with the third animation as a potential label for the third animation in response to determining to allow access to the user.
Clause 2. The apparatus of clause 1, wherein the respective correct label includes an indication of an actor in the animation and an indication of an action in the animation.
Clause 3. The apparatus of clause 2, wherein the actor in the first animation is different than the actor in the second animation.
Clause 4. The apparatus of any of clauses 1-3, wherein the first animation and the second animation are selected from a pool of labeled animations and the third animation is selected from a pool of unlabeled animations.
Clause 5. The apparatus of clause 4, wherein the one or more processors, individually or in combination, are configured to add the third animation to the pool of labeled animations with the potential label as a correct label for the third animation in response to a number of potential labels for the third animation from a plurality of allowed users being the same and satisfying a threshold number.
Clause 6. The apparatus of any of clauses 1-5, wherein to transmit the at least three animations for display to the user on a client device, the one or more processors, individually or in combination, are configured to transmit selectable labels for the first animation and the second animation, wherein the selectable labels include the respective correct label for the first animation and the respective correct label for the second animation to be displayed with at least two incorrect labels for each of the first animation and the second animation, wherein the user selects the input of the respective selected label for each of the first animation and the second animation from the selectable labels.
Clause 7. The apparatus of any of clauses 1-6, wherein the input of the respective selected label for the third animation is a text entry generated by the user.
Clause 8. The apparatus of clause 7, wherein the one or more processors, individually or in combination, are configured to perform statistical clustering of text entries of potential labels for the third animation from a plurality of users to select a correct label for the third animation.
Clause 9. The apparatus of any of clauses 1-8, wherein the one or more processors, individually or in combination, are configured to transmit selectable labels for the third animation, wherein the selectable labels include randomly generated combinations of actors and actions or potential labels for the third animation that were previously input by other users.
Clause 10. The apparatus of clause 8, herein the one or more processors, individually or in combination, are configured to associate a potential label for the third animation as a correct label for the third animation in response to the potential label being selected by a threshold number of users.
Clause 11. The apparatus of any of clauses 1-10, wherein the one or more processors, individually or in combination, are configured to determine whether to allow access to the user based at least in part on whether the input of the respective selected label for each of the at least three animations is received within a time limit.
Clause 12. A method of verifying whether to allow a user access to a resource, comprising: transmitting at least three animations for display to the user on a client device, wherein at least a first animation and a second animation of the at least three animations are associated with a respective correct label and at least a third animation of the animations is not associated with a correct label; receiving, from the client device, an input of a respective selected label for each of the at least three animations; determining whether to allow the user access to the resource based at least in part on the respective selected label of the first animation being the respective correct label for the first animation and the respective selected label of the second animation being the respective correct label for the second animation; and associating the respective selected label for the third animation with the third animation as a potential label for the third animation in response to determining to allow access to the user.
Clause 13. The method of clause 12, wherein the respective correct label includes an indication of an actor in the animation and an indication of an action in the animation, wherein the actor in the first animation is different than the actor in the second animation.
Clause 14. The method of clause 12 or 13, wherein the first animation and the second animation are selected from a pool of labeled animations and the third animation is selected from a pool of unlabeled animations, the method further comprising adding the third animation to the pool of labeled animations with the potential label as a correct label for the third animation in response to a number of potential labels for the third animation from a plurality of allowed users being the same and satisfying a threshold number.
Clause 15. The method of any of clauses 12-14, wherein transmitting at least three animations for display to the user on a client device comprises transmitting selectable labels for the first animation and the second animation, wherein the selectable labels include the respective correct label for the first animation and the respective correct label for the second animation to be displayed with at least two incorrect labels for each of the first animation and the second animation, wherein the user selects the input of the respective selected label for each of the first animation and the second animation from the selectable labels.
Clause 16. The method of any of clauses 12-15, wherein the input of the respective selected label for the third animation is a text entry generated by the user, the method, further comprising performing statistical clustering of text entries of potential labels for the third animation from a plurality of users to select a correct label for the third animation.
Clause 17. The method of any of clauses 12-16, further comprising transmitting selectable labels for the third animation, wherein the selectable labels include randomly generated combinations of actors and actions or potential labels for the third animation that were previously input by other users.
Clause 18. The method of clause 17, further comprising associating a potential label for the third animation as a correct label for the third animation in response to the potential label being selected by a threshold number of users.
Clause 19. The method of any of clauses 12-18, wherein determining whether to allow access to the user is also based on whether the input of the respective selected label for each of the at least three animations is received within a time limit.
Clause 20. A non-transitory computer-readable medium comprising computer-executable instructions for verifying whether to allow a user access to a resource, wherein execution of the instructions by a processor causes the processor to: transmit at least three animations for display to the user on a client device, wherein at least a first animation and a second animation of the at least three animations are associated with a respective correct label and at least a third animation of the animations is not associated with a correct label; receive, from the client device, an input of a respective selected label for each of the at least three animations; determine whether to allow access to the user based at least in part on the respective selected label of the first animation being the respective correct label for the first animation and the respective selected label of the second animation being the respective correct label for the second animation; and associate the respective selected label for the third animation with the third animation as a potential label for the third animation in response to determining to allow access to the user.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus for verifying whether to allow a user access to a resource, comprising:
one or more memories storing computer-executable instructions; and
one or more processors configured to execute the instructions, wherein execution of the instructions causes the apparatus to:
transmit at least three animations for display to the user on a client device, wherein at least a first animation and a second animation of the at least three animations are associated with a respective correct label and at least a third animation of the animations is not associated with a correct label;
receive, from the client device, an input of a respective selected label for each of the at least three animations;
determine whether to allow access to the user based at least in part on the respective selected label of the first animation being the respective correct label for the first animation and the respective selected label of the second animation being the respective correct label for the second animation; and
associate the respective selected label for the third animation with the third animation as a potential label for the third animation in response to determining to allow access to the user.

2. The apparatus of claim 1, wherein the respective correct label includes an indication of an actor in the animation and an indication of an action in the animation.

3. The apparatus of claim 2, wherein the actor in the first animation is different than the actor in the second animation.

4. The apparatus of claim 1, wherein the first animation and the second animation are selected from a pool of labeled animations and the third animation is selected from a pool of unlabeled animations.

5. The apparatus of claim 4, wherein the one or more processors, individually or in combination, are configured to add the third animation to the pool of labeled animations with the potential label as a correct label for the third animation in response to a number of potential labels for the third animation from a plurality of allowed users being the same and satisfying a threshold number.

6. The apparatus of claim 1, wherein to transmit the at least three animations for display to the user on a client device, the one or more processors, individually or in combination, are configured to transmit selectable labels for the first animation and the second animation, wherein the selectable labels include the respective correct label for the first animation and the respective correct label for the second animation to be displayed with at least two incorrect labels for each of the first animation and the second animation, wherein the user selects the input of the respective selected label for each of the first animation and the second animation from the selectable labels.

7. The apparatus of claim 1, wherein the input of the respective selected label for the third animation is a text entry generated by the user.

8. The apparatus of claim 7, wherein the one or more processors, individually or in combination, are configured to perform statistical clustering of text entries of potential labels for the third animation from a plurality of users to select a correct label for the third animation.

9. The apparatus of claim 1, wherein the one or more processors, individually or in combination, are configured to transmit selectable labels for the third animation, wherein the selectable labels include randomly generated combinations of actors and actions or potential labels for the third animation that were previously input by other users.

10. The apparatus of claim 8, herein the one or more processors, individually or in combination, are configured to associate a potential label for the third animation as a correct label for the third animation in response to the potential label being selected by a threshold number of users.

11. The apparatus of claim 1, wherein the one or more processors, individually or in combination, are configured to determine whether to allow access to the user based at least in part on whether the input of the respective selected label for each of the at least three animations is received within a time limit.

12. A method of verifying whether to allow a user access to a resource, comprising:
transmitting at least three animations for display to the user on a client device, wherein at least a first animation and a second animation of the at least three animations are associated with a respective correct label and at least a third animation of the animations is not associated with a correct label;
receiving, from the client device, an input of a respective selected label for each of the at least three animations;
determining whether to allow the user access to the resource based at least in part on the respective selected label of the first animation being the respective correct label for the first animation and the respective selected label of the second animation being the respective correct label for the second animation; and
associating the respective selected label for the third animation with the third animation as a potential label for the third animation in response to determining to allow access to the user.

13. The method of claim 12, wherein the respective correct label includes an indication of an actor in the animation and an indication of an action in the animation, wherein the actor in the first animation is different than the actor in the second animation.

14. The method of claim 12, wherein the first animation and the second animation are selected from a pool of labeled animations and the third animation is selected from a pool of unlabeled animations, the method further comprising adding the third animation to the pool of labeled animations with the potential label as a correct label for the third animation in response to a number of potential labels for the third animation from a plurality of allowed users being the same and satisfying a threshold number.

15. The method of claim 12, wherein transmitting at least three animations for display to the user on a client device comprises transmitting selectable labels for the first animation and the second animation, wherein the selectable labels include the respective correct label for the first animation and the respective correct label for the second animation to be displayed with at least two incorrect labels for each of the first animation and the second animation, wherein the user selects the input of the respective selected label for each of the first animation and the second animation from the selectable labels.

16. The method of claim 12, wherein the input of the respective selected label for the third animation is a text entry generated by the user, the method, further comprising performing statistical clustering of text entries of potential labels for the third animation from a plurality of users to select a correct label for the third animation.

17. The method of claim 12, further comprising transmitting selectable labels for the third animation, wherein the selectable labels include randomly generated combinations of actors and actions or potential labels for the third animation that were previously input by other users.

18. The method of claim 17, further comprising associating a potential label for the third animation as a correct label for the third animation in response to the potential label being selected by a threshold number of users.

19. The method of claim 12, wherein determining whether to allow access to the user is also based on whether the input of the respective selected label for each of the at least three animations is received within a time limit.

20. A non-transitory computer-readable medium storing computer-executable instructions for verifying whether to allow a user access to a resource, wherein execution of the instructions by a processor causes the processor to:
transmit at least three animations for display to the user on a client device, wherein at least a first animation and a second animation of the at least three animations are associated with a respective correct label and at least a third animation of the animations is not associated with a correct label;
receive, from the client device, an input of a respective selected label for each of the at least three animations;
determine whether to allow access to the user based at least in part on the respective selected label of the first animation being the respective correct label for the first animation and the respective selected label of the second animation being the respective correct label for the second animation; and
associate the respective selected label for the third animation with the third animation as a potential label for the third animation in response to determining to allow access to the user.
